(19) United States
(12) Patent Application Publication
(10) Pub. No.: US 2026/0118880 A1
(43) Pub. Date: Apr. 30, 2026

(54) END-TO-END RANGE-BASED CONTROLLERS FOR NAVIGATING ENVIRONMENTS

(71) Applicant: University of Kentucky Research Foundation, Lexington, KY (US)

(72) Inventor: Hasan Alihusain Poonawala, Lexington, KY (US)

(21) Appl. No.: 19/374,268

(22) Filed: Oct. 30, 2025

Related U.S. Application Data
(60) Provisional application No. 63/714,426, filed on Oct. 31, 2024.

(51) Int. Cl. G05D 1/622

(52) U.S. Cl. CPC G05D 1/622

(57) ABSTRACT

Embodiments include a system for navigating an environment. In some embodiments, the system includes a robot, a sensor, and a computing device. The computing device may cause the system to receive a local map of the environment, define a desired path of the robot in the environment, and predict sensor readings of the sensor at a location on the local map and a location off the path using the local map. In some embodiments, the computing device causes the system to predict a spatial derivative of a parameterized controller at a location on the path, predict controller output values at a location on the desired path using the sensor readings, and compute controller parameter values such that that the spatial derivative and the controller output values are closer to satisfying a predetermined mathematical condition. Some embodiments evaluate whether the predetermined mathematical condition is satisfied.

### CROSS REFERENCE

This application claims the benefit of U.S. Provisional Application Ser. No. 63/714,426, filed Oct. 31, 2024, which is hereby incorporated by reference in its entirety.

### TECHNICAL FIELD

Embodiments described herein generally relate to systems and methods for end-to-end range-based controllers for navigating indoor and/or outdoor environments and, more specifically, to embodiments that enable a robot to apply specific mathematical conditions to compute a controller using an automated procedure applied to virtual or physical sensor measurements collected within the environment the robot is navigating.

### BACKGROUND

The demand for efficient and accurate navigation of autonomous robots has never been more acute. As economies advance and become increasingly complex, the need for reliable and precise autonomous robot navigation is becoming more desired. Environments like warehouses, hospitals, and offices are intricate, high-density environments where robots must seamlessly weave through tight spaces, avoid collisions, and optimize their routes to meet ever-growing demands. The ability to navigate these environments relies on effective utilization of sensor information to make motion decisions.

As such, a need exists across industries for systems and methods for end-to-end sensor-based controllers for navigating indoor environments, as described herein.

### SUMMARY

Embodiments include a system for navigating an environment. In some embodiments, the system includes a robot, a sensor, and a computing device. The computing device may cause the system to receive a local map of the environment, define a desired path of the robot in the environment, and predict sensor readings of the sensor at a location on the local map and a location off the path using the local map. In some embodiments, the computing device causes the system to predict a spatial derivative of a parameterized controller at a location on the path, predict controller output values at a location on the desired path using the sensor readings, and compute controller parameter values such that that the spatial derivative and the controller output values are closer to satisfying a predetermined mathematical condition. Some embodiments evaluate whether the predetermined mathematical condition is satisfied.

Another embodiment of a system includes a robot with at least one sensor and a computing device that is coupled to the robot. The computing device may cause the system to receive a local map of the environment, define a desired path of the robot in the environment, where the path is represented as a sequence of locations in the environment, and predict sensor readings of the sensor at a location on the path using the local map, where predicting sensor readings includes creating and utilizing a digital twin of the local map. In some embodiments, the computing device causes the system to design an end-to-end range-based controller for the robot, predict a spatial derivative of the end-to-end range-based controller at a location on the path, and predict controller output values of the end-to-end range-based controller at a location on the desired path using the sensor readings. In some embodiments, the computing device causes the system to compute controller parameter values such that that the spatial derivative and the controller output values are closer to satisfying a predetermined mathematical condition, evaluate whether the predetermined mathematical condition is satisfied, and in response to determining that the predetermined mathematical condition is satisfied, execute the controller parameter values to control the robot through the environment.

Another embodiment of a system includes a robot with at least one sensor and a computing device that is coupled to the robot. The computing device may cause the system to receive a local map of the environment, define a desired path of the robot in the environment, where the path is represented as a sequence of locations in the environment, and predict sensor readings of the sensor at a location off the path using the local map, where predicting sensor readings includes creating and utilizing a digital twin of the local map. In some embodiments, the computing device causes the system to design an end-to-end controller for the robot, predict a spatial derivative of the end-to-end controller at a location on the path, and predict controller output values of the end-to-end controller at a location on the desired path using the sensor readings. Some embodiments of the computing device cause the system to compute controller parameter values such that that the spatial derivative and the controller output values are closer to satisfying a predetermined mathematical condition, evaluate whether the predetermined mathematical condition is satisfied, and in response to determining that the predetermined mathematical condition is satisfied, execute the controller parameter values to control the robot through the environment.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts a block diagram related to navigation using SLAM that utilizes centimeter-level accurate localization relative to a known route in a known map, according to embodiments provided herein;

FIG. 2 depicts a proposed framework for deploying end-to-end navigation controllers designed on-the-fly for zones in an environment, according to embodiments provided herein;

FIG. 3A depicts LiDAR sensor returns distance or range r along directions parametrized by ø, according to embodiments provided herein;

FIG. 3B depicts an AMR with forward speed and angular velocity, according to embodiments provided herein;

FIG. 4 depicts an end-to-end controller navigating a cluttered environment without localization in simulation, according to embodiments provided herein;

FIG. 5 depicts a digital twin of an environment that can be used to synthesize data-driven controllers that achieve target navigation behaviors for each zone, according to embodiments provided herein;

FIG. 6 depicts utilizing deep learning models for vision to provide direction-dependent information to use in a manner similar to use of range-based sensors, according to embodiments provided herein;

FIG. 7 depicts a flowchart for training end-to-end range-based controllers for navigating indoor environments, according to embodiments provided herein;

FIG. 8 depicts a flowchart for running a controller, according to embodiments provided herein;

FIG. 9 depicts a system for controller management, according to embodiments provided herein; and

FIG. 10 depicts a computing device for providing end-to-end range-based controllers for navigating indoor environments, according to embodiments provided herein.

### DETAILED DESCRIPTION

Embodiments disclosed herein include systems and methods for providing an end-to-end sensor-based controller (at least one) for navigating environments, such as warehouses, indoor environments, outdoor environments, etc. Some embodiments may be configured to advance the reliability of navigation controllers for autonomous mobile robots (AMRs) that use robot at least one sensor such as a LiDAR system, an image capture device (e.g., a depth camera), a radar system, real time location system (RTLS) sensor, etc. to navigate, especially around other robots or humans in their vicinity. The embodiments provided herein involve evaluation of on-the-fly design of controllers for AMRs navigating in warehouse-like environments in scenarios where other robots or humans are present.

These embodiments can connect low-level motion controllers with the higher-level reasoning that large foundation models provide. AMRs may be used by non-experts to execute tasks in complex situations. One example of ease-of-use is to instruct a robot using spoken natural language. For example, asking the robot to find a pallet with yellow cans located in one zone and bring it to another zone in the environment. Another example would be to draw a desired route on a map of the environment.

For an AMR to automatically execute flexible instructions, embodiments may provide an automated framework that can generate reliable navigation strategies from those instructions, while respecting the background constraints in the environment. Safety requirements demand complex coordination of the robot with other people, robots, and objects in the environment. The robots themselves rely on a highly structured and predictable environment to enable map-based navigation, where changes to the local map or uncertainties in sensing can impede navigation safety and effectiveness. Managing the complexity of environments is challenging for current approaches, leading to inflexible operations in most cases. Therefore, new ideas are required to achieve this vision of parsing broad human instructions, whatever the computer interface (audio, keyboard, tablet, etc.), into robot motion. The systems and methods for end-to-end range-based controllers for navigating environments incorporating the same will be described in more detail, below.

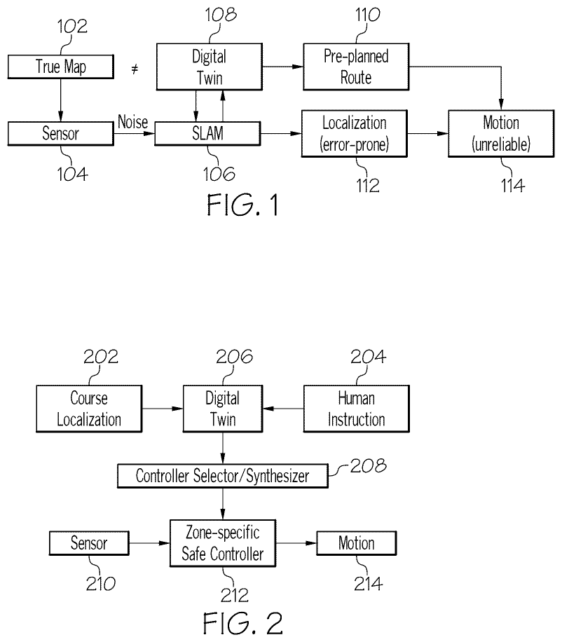

Referring now to the drawings, FIG. 1 depicts a block diagram related to navigation using SLAM that relies on centimeter-level accurate localization relative to a known route in a known map, according to embodiments provided herein. Sensor noise can confuse a robot, leading to a stopped robot that needs rescuing. Lack of reliability limits flexibility in operations. Simultaneous localization and mapping (SLAM) algorithms have been effective for navigating static environments. However, localization relative to a map is unreliable for navigation in dynamic environments. SLAM algorithms may seemingly behave well even in dynamic environments, but observation of unexpected objects can occasionally cause large localization errors. These occasional large errors can lead to collisions. SLAM is reasonably good at creating a map, but not at maintaining a digital twin (an updatable map). Another disadvantage of SLAM-based navigation is the need to manually traverse routes and obtain maps during an initialization process, followed by an extended safe route design process. Some embodiments provided herein utilize end-to-end navigation controllers where the robot chooses motion commands in direct response to what it observes.

Specifically referring to the process of FIG. 1, a true map 102 is combined with sensor data and sent to the SLAM algorithm 106. The digital twin 108 is then utilized to create a pre-planned route 110. However, the process introduces noise so that in creating a digital twin 108 and performing localization 112, results in errors in the data and instructions. From the pre-planned route 110 and the localization 112, motion 114 of the AMR may be actuated.

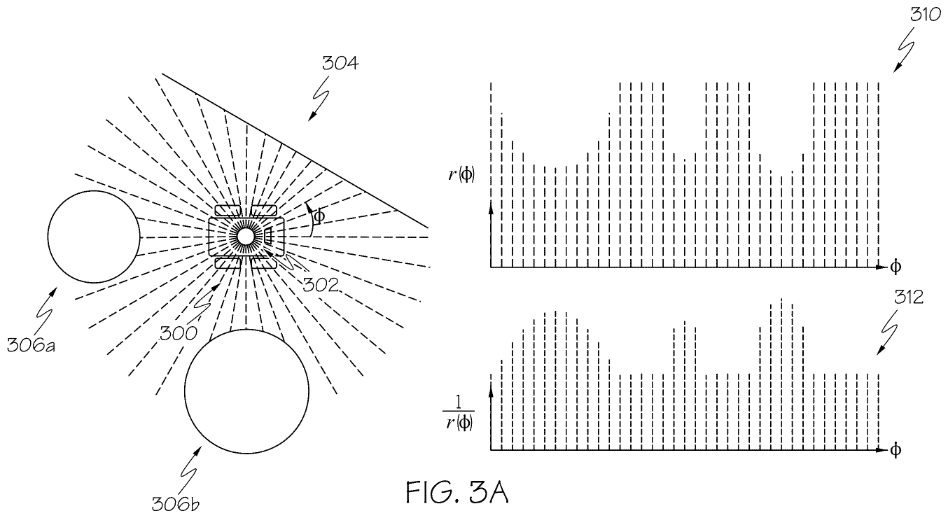

FIG. 2 depicts a proposed framework for providing end-to-end navigation controllers on-the-fly, according to embodiments provided herein. These embodiments may be configured to decouple localization from motion generation by using end-to-end controllers for motion and a coarse localization (e.g. from real time locating system (RTLS) sensors) for designing end-to-end controllers for specific zones. A digital twin can use coarse localization to switch controllers in and out in a flexible way to produce reliable long-range navigation through a facility. Embodiments provided herein may be configured to evaluate proposed methods to build controllers on-the-fly from simple instructions. Some embodiments will pursue the following objectives: (1) develop a tool to analyze the long-term safety and performance of any end-to-end navigation strategy using a map or digital twin of an environment; (2) create a physical test environment that simulates approximate real-time localization systems using optical cameras and fiducial-based vision; (3) implement object detection algorithms on edge machine learning (ML) devices (e.g., Jetson Nano/Orin) and a flexible procedure to combine their predictions with navigation controllers; and (3) demonstrate reliable end-to-end navigation of a robot through an environment with obstacles and humans.

Sensor-based navigation is an important capability for AMRs. However, the reliability of existing machine-learning-based methods and SLAM-based methods is limited. On-the-fly design of controllers is a potentially transformative technology for AMRs, improving reliability while reducing controller training and deployment costs. The embodiments provided herein provide a computationally efficient way to assess and reduce the risk of AMR operation when using new sensor-based navigation methods. Some embodiments address standards for integration of AMRs and soon-to-be-released standards for sensor fusion.

Referring specifically to FIG. 2, these embodiments may provide coarse localization 202 and human instruction 204 to the digital twin 206, which then selects or computes a zone-specific safe controller 212 that is executed on the robot. The execution of the zone specific controller 212 uses the sensor data 210 is sent actuate motion 214 on the AMR in the form or target positions or desired velocities.

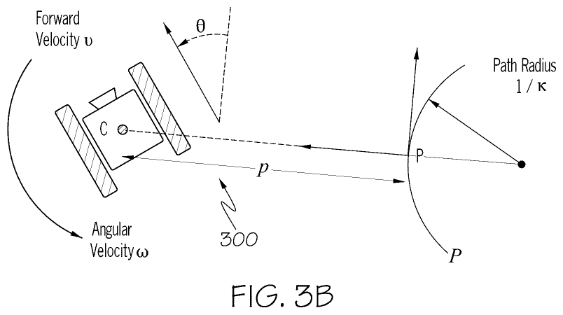

FIG. 3 depicts an AMR 300 with a LiDAR sensor 302 that returns distance or range r along directions parametrized by ø, according to embodiments provided herein. Mapping such readings to motion commands typically relied on hard-coded heuristics or heuristics-guided learning. Some embodiments include algorithms that emphasize correct-by-design navigation controllers that are end-to-end, meaning they map sensor readings (e.g., LiDAR, depth cameras, etc.) directly to motion commands, without intermediate state estimation. For example, choosing velocities for the AMR 300 using a weighted sum of distances returned by the LiDAR sensor 302 (e.g., a 2D LiDAR) can be shown to avoid collisions with walls 304 and circular objects 306a, 306b, even if the AMR 300 never stops moving. Safety without stopping can dramatically improve the throughput of AMR 300 tasks.

Some embodiments exploit structure in the range scan r(φ), or the proximity scan 1/r(φ), that objects produce when in the field of view of a range the LiDAR sensor 302 like 2D LiDAR. A 2D LiDAR provides the distances r to (certain) surfaces at different angles φ in the LiDAR frame. FIG. 3 provides an example of range and proximity scans. Current solutions may rely on heuristic rules for converting the range scan into movement rules. Embodiments herein provide mappings of range scans r(φ) 310 (and inverse range scans 312) so that the long-term feedback between the LiDAR sensor 302 and the object 306 producing the range scan 310 behaves appropriately, without relying on the exact values of the range scan 310 being a certain value. For example, these embodiments can summarize the range scan r(φ) 310 produced by the object 306a to always possess certain properties, no matter where the object 306a is relative the LiDAR sensor 302. Embodiments can additionally design structured end-to-end controllers that exploit these properties to ensure that the AMR 300 turns away from the object 306a, without knowing the details of the relative position or size of the object 306a ahead of time. These controllers provide guaranteed behavior around objects of appropriate shape and kind. This formalization of the interaction between the range scan r(φ) 310 and object properties provides improved guarantees.

FIG. 3B depicts an AMR 300 with forward speed (v) and angular velocity (ω), according to embodiments provided herein. As illustrated, the AMR 300 with forward speed v, and angular velocity ω is represented with a curved line that represents a local segment of the path P, with instantaneous path curvature κ, that the AMR 300 must follow. The local Frenet-Serret frame attached to the path P is also shown. The state of the AMR 300 includes the cross-track error p and angle θ with respect to the path P. Specifically, A planar path P refers to a curve in the plane R2. The kinematics of the AMR 300 may be expressed in a local statespace representation known as the “orthogonal projection” of the AMR 300 centroid C about a path P. The closest point P on P to centroid C, which defines a local Frenet-Serret frame, inducing path-local variables θ and p, with arc length s defining the 1D coordinate of P on P. Variable p is the signed distance of the point P from the path, and θ is the difference between the heading direction of the mobile robot and the tangent to the path. The robot has a linear or forward velocity v and an angular velocity ω about C.

A generic curve has a varying curvature κ(s) along the path P. Convergence to such a path is impossible without feed-forward control of the path. Therefore, these embodiments utilize conditions derived from analysis of fixed-curvature paths, meaning κ(s)≡κ. Under fixed curvature, the following dynamics model for state \vec{x}=(θ,p) may be obtained via

$$\begin{matrix}\dot{p} & = v sin θ \\ \dot{θ} & = ω - \frac{κ v cos θ}{1 - p κ}\end{matrix} .$$

As such, embodiments provided herein include a controller that specifies velocities v, ω that ensure that p(t)→0 as t→∞ and that \dot{s}(t)>0 for all times.

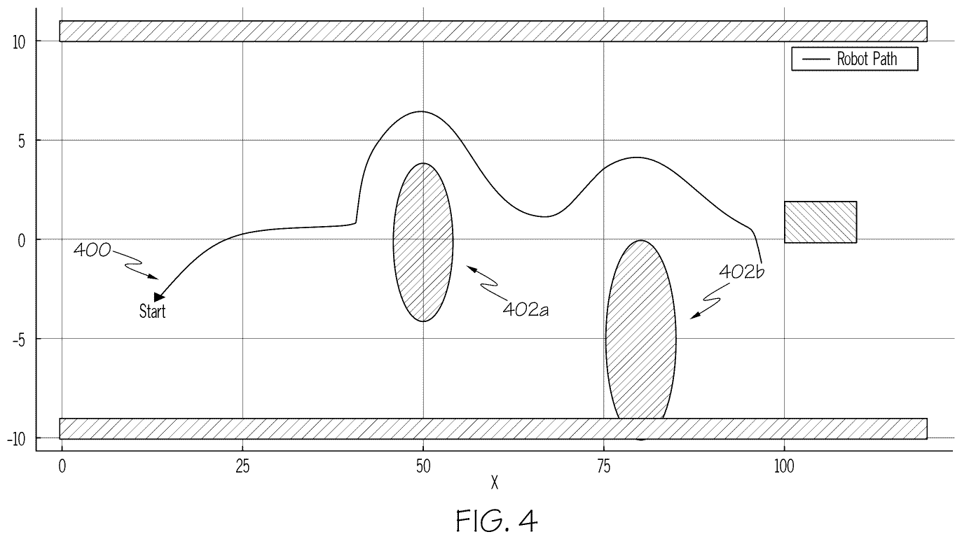

FIG. 4 depicts single end-to-end controller 400 successfully navigating a cluttered environment without any localization in simulation, according to embodiments provided herein. For simple environments, like a corridor with vertical parallel walls or empty space with a single circular object 402 (e.g., 402a, 402b), an end-to-end controller 400 with guaranteed behavior can be designed in closed-form. For more complicated environments, embodiments may be configured to lead to algorithms for turning data from the environment into reliable controllers that execute certain behaviors, such as following paths between walls and objects 402. Some systems provide conditions on any controller to ensure path-following behavior, which using LiDAR can be interpreted as avoiding the two walls defining a path at the same time. This capability enables free-roaming AMRs to follow and return to virtual lanes in an environment, streamlining operations. However, unlike generic deep neural network models, these embodiments enable simpler controller model architectures that can be trained using efficient optimization algorithms, in contrast to stochastic gradient descent.

Computational efficiency and low data requirements lead to algorithms that can design accurate controllers on-the-fly using data collected in real-time from the environment, or a suitable digital twin model of it. Some embodiments utilize only about 200 depth images from a corridor to train a successful controller. Notably, the controller may be configured to operate on a depth image of size 640×480 and may achieve a control rate of 10 Hz. Some embodiments may be configured for navigating empty corridor-like environments, with successful simulation and experimental results. These embodiments evaluate the ability of such on-the-fly controllers to safely continue navigation around obstacles or objects such as other robots or humans, using LiDAR and depth cameras as sensors.

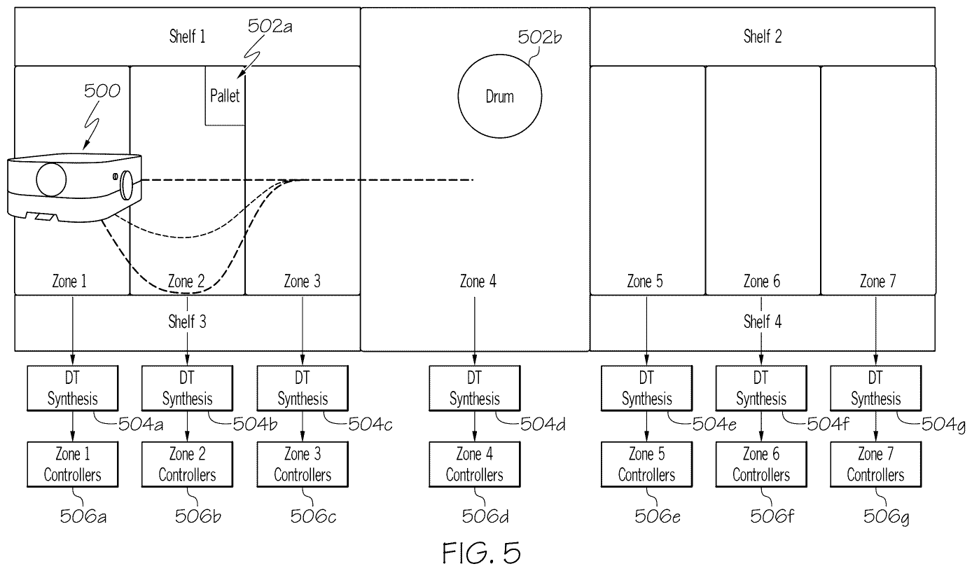

FIG. 5 depicts use of a digital twin to synthesize data-driven controllers that achieve target navigation behaviors for each zone, according to embodiments provided herein. These behaviors include navigating through one or more zone (or a plurality of zones), while accounting for relevant objects in the zones. These embodiments improve reliability of navigation behaviors in AMRs by combining three technologies: (1) End-to-end controllers using LiDAR and depth cameras for feedback; (2) Digital twins of facilities for zone-specific analysis or selection of controllers; and (3) Sensor-based object recognition on edge-ML devices.

Accordingly, embodiments provided herein pursue the following tasks: (a) develop tools to analyze the performance of any end-to-end navigation strategy using a map or digital twin of an environment; (b) create a physical test environment that simulates approximate localization using ultra-wide-band (UWB) technologies; (c) implement object detection models on edge-ML devices (Jetson Nano/Orin) and combine models outputs with inherently-safe navigation controllers, (d) design a procedure to decode natural language into rules for combining inherently-safe navigation controllers with deep learning models that predict object presence.

Environments like warehouses are often first mapped to enable robot navigation. A map typically identifies occupied and unoccupied regions of 3D space. These maps may also provide a mechanism to predict the visual appearance or image formed by a camera in different locations. However, a map is typically static and pre-built.

In some embodiments, a digital twin of the environment refers to a facility-level updatable map, within which the locations of equipment (including robots), people, and physical objects can be updated in real-time. A facility will often use a more complicated digital twin, in which physical processes beyond robot movements are represented. Traditional robotics algorithms like SLAM are effectively maintaining a robot-level digital twin of the environment for navigation. This means the robot maintains the digital twin, instead of a separate computing device in the facility.

Task 1 may use maps or digital twins to enable on-the-fly design of controllers 506a-506g that are tailored to specific zones, via respective digital twin (DT) synthesis components 504a-504g. FIG. 5 depicts a partition of a warehouse map into zones. For each zone, zone controllers 506a-506g can achieve navigation behaviors such as navigating along the middle or following one of the walls at a desired clearance, etc., using embodiments provided herein for training structured end-to-end controllers. The data requirements are expected to be on the order of only hundreds of samples, unlike the case of deep learning models that need far more. Such behaviors controller of controllers 506 effectively enable motion between zones. Moreover, these controllers 506 guarantee avoidance of obstacles of some shapes. Dealing with object attributes other than shape will be handled using object recognition models in Task 3 (implementing object detection models on edge-ML devices background: deep learning for object recognition).

Task 2 (implementing mock warehouse with real-time location system) includes switching between appropriate zone-specific controllers 506 to safely and reliably execute long-range routes in an environment. A real-time localization service, one that only needs zone-level accuracy, will enable appropriate switching.

The inherent-safety applies once the robot is close to an obstacle, much closer than to other objects in an environment. When the AMR is close to multiple objects, the behavior of the AMR depends on the environment.

Task 2 may develop a physical test environment within which a wheeled robot mobile 500 will navigate, simulating navigation tasks for an AMR in an environment, such as a warehouse. The wheeled robot mobile 500 will receive commands over wireless internet, either through an ad-hoc network (e.g., using Espressif's ESP32) or through device-only Wi-Fi. A form of real-time location may be obtained using cameras in conjunction with AprilTags. The resulting vision system may be configured for highly accurate positioning post-calibration. The high-accuracy positions may be used to determine the zone that the wheeled robot mobile 500 is in, and for post-experiment data visualization and analysis. The zone-level resolution aims to mimic the typical accuracy from systems that use Ultra-Wide-Band (UWB) technology, which is about 3 feet. The wheeled robot mobile 500 may switch between controllers based on the zone the wheeled robot mobile 500 is in, assuming a controller has been designed for each zone in Task 1. Multiple zones may use the same controller 506. The environment will contain obstacles include a mock pallet 502a, a mock drum 502b, humans, etc.

Task 3 involves implementing object detection models on edge-ML devices using deep learning for object recognition. Specifically, deep learning has significantly advanced the ability to process camera images into useful information. Object recognition has always been an important task. Recent models not only recognize the presence of objects, but can also identify the regions of the image containing the image (object segmentation). Embodiments provided herein leverage these advances to define new object-specific safe navigation behaviors.

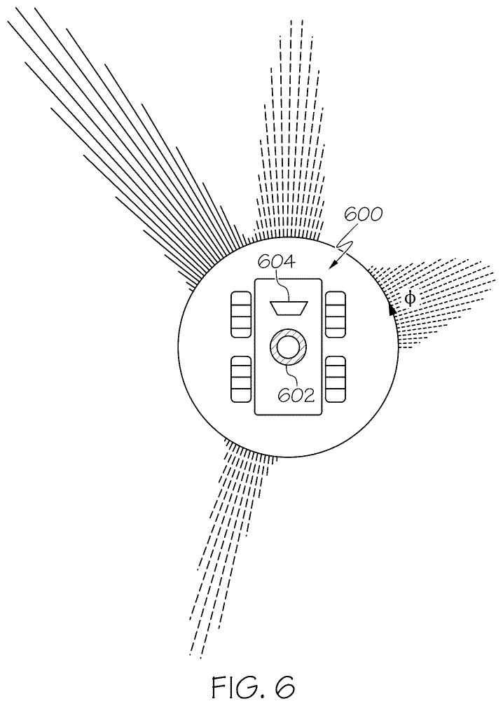

FIG. 6 depicts utilizing deep learning models for vision to provide along a direction-dependent measures that go beyond direction-dependent distance depicted in FIG. 3, according to embodiments provided herein. Despite some impressive abilities, combining the information from these models into navigation commands has remained challenging. Embodiments provided herein provide a way to effectively integrate these models. The navigation behaviors of this disclosure rely more on the relative value of the range in different directions more than on the specific values of the range in any direction. These embodiments replace range measurements from LiDAR with other direction-dependent quantities as long as their relative values along directions show similar behaviors to range r or proximity 1/r. These direction-dependent quantities can be derived from deep learning models for computer vision.

This task may implement object detection algorithms on the Jetson Nano or Orin to generate a feedback signal for navigation in real robot experiments. Embodiments provided below may utilize on the YOLO model (version 9) for detecting humans, and the pallet models for detecting pallets. These models focus on real-time performance, compatible with NVIDIA Jetson processors. These models can segment the images, providing a region in the image that likely corresponds to the objects. These predictions may be processed to create a signal that behaves similar to a proximity measurement 1/r(φ). The object detection terms can be used as a separate control term that is added to the LiDAR-based term, or it can be used to modulate the reading from the LiDAR system 602, to make the AMR 600 more or less sensitive to the presence of an object.

The information coming from the LiDAR system 602 and depth cameras 604 has a clear physical behavior. Getting closer to an object will reduce the distance to it, even if it is not clear what the object is. This consistent physical behavior underlies the strong guarantees of embodiments provided herein for end-to-end controllers using feedback from the LiDAR system 602. Identifying the object, however, may provide improved navigation behaviors. For example, navigating around humans and pallets using different clearances or strategies, especially in narrow aisles.

The outputs of a generative AI model may not behave in the same spatially consistent way that relative distance does. In general, it is expected that the closer to an object, the more information gathered, and therefore the higher confidence about what the object is. Even if the outputs of the generative model do not behave like a relative distance reading, their behavior may still lead to acceptable motions of the AMR 600 when used for decision-making.

Task 4 includes evaluating on-the-fly designed end-to-end navigation controllers. The three previous tasks lay the groundwork for evaluating the ability to design safe navigation controllers on-the-fly. The term on-the-fly refers to the controller-one that is inherently safe-which is chosen in response to updated conditions in a digital twin, allowing flexible yet reliable robot behaviors. For example, a high-level plan through appropriate zones will enable movement of the AMR 600 from one zone to another zone. If, as illustrate in FIG. 5, there are pallets 504 left in a location along the route in a zone, the controller 506 for the appropriate zone can be combined with an object detection model to navigate near such objects. The digital twin can be used as a simulator to synthesize a safe data-driven controller to ensure sufficient clearances while navigating around the object.

There are two scenarios for on-the-fly design using end-to-end navigation controllers: first is the ‘lost’ robot that reappears in a zone, necessitating a new route and controller that enables the AMR 600 to resume operations; and the second is the unanticipated change in the objects located in a zone.

Under the first scenario, an existing route with associated controllers 506 through a sequence of zones in the physical mock warehouse from Task 2 may be considered. This task may involve introducing pallets in randomly selected zones, and updating the corresponding digital twin model of the environment. On this update, new controllers may be synthesized using data-driven methods, where data is sourced from the digital twin. The resulting route will be executed, from different locations in the zones along the route.

In the second scenario, the AMR 600 will be ‘kidnapped’ and repositioned along the route. A new route will be planned, along with any zone-specific controllers, to return the AMR 600 to its original task.

The entire system may be evaluated in each of the two scenarios in terms of the success rate of the task normalized by length of the planned route (SPL). A task fails if the robot collides with an object or walls in the environment, or if the robot fails to execute a planned transition between two zones. For example, turning around while inside an aisle instead of proceeding along the path by going around an object.

The progress may be marked by five milestones: M3 Selection of environment layout and validation of zone-specific inherently safe controllers that can transition through any zone in the environment when no obstacles are present using a map; M6 Implementation of a digital twin model of the environment with capability to set robot controller remotely and monitor zone-membership in real-time; M9 Implementation of pre-trained deep learning models for object detection and processing of the model outputs for object-based navigation; M12 Demonstration of safe robot motion through the environment using natural language command. It should be noted that ‘M3’ indicates that the corresponding milestone will be achieved during the third project month, and so on.

Accordingly, embodiments provided herein create at least the following outcomes: (1) Evaluation of the reliability of proposed object-aware end-to-end navigation controllers around single people or obstacles; (2) Demonstrate navigation through complex environments using on-the-fly range-based controllers without SLAM; (3) Generate real-world data for future training of object recognition models as navigation stack components; (4) Evaluate metrics like real-time performance, cost, and identify integration challenges with autonomous mobile robots in production.

As such, embodiments may be configured to verify the likely success of collision avoidance strategies involving both speed and steer control for AMRs while accounting for the layout of the environment. Moreover, these algorithms can characterize the set of locations that the AMR remains within, enabling classification of safety zones that account for collision avoidance behavior. The algorithms will be implemented using the Robot Operating System (ROS) simulation environment, enabling future implementation on real systems using data encapsulated in digital twins.

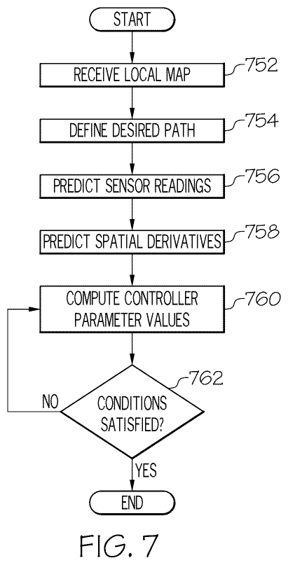

FIG. 7 depicts a flowchart for training end-to-end range-based controllers for navigating indoor environments, according to embodiments provided herein. As illustrated in block 752, a local map of the environment may be received from the latest processed sensor data and/or from a cloud computing device. The local map may include an overhead map, a point cloud, and/or other representation of the environment. In block 754, a desired path through a local environment may be defined and/or received. The path may be received as a sequence of locations in the environment. The path does not need to pass through the predicted true current robot location in the local map. In block 756, sensor readings may be predicted at a first location on the path and a second location off the path using a local map. Specifically, a digital twin may be utilized for predicting sensor readings. In block 758, a spatial derivative (or more than one) of a parameterized controller (at least one) may be predicted at some or all locations on the path and the controller output values may be predicted at locations on the path using the predicted sensor data. Embodiments herein may use different strategies to predict spatial derivatives, including finite difference approximation using sensor readings in nearby positions, or use of differentiable simulators. In block 760, controller parameter values may be computed and/or changed so that the spatial derivatives and the controller values are closer to satisfying predetermined mathematical conditions. In block 762, an evaluation of whether the mathematical conditions have been satisfied may be performed. If the conditions are not satisfied, the process may return to block 760. If the conditions have been satisfied, the process may end. These condition are given by:

$$ω = 0 when p = 0 and θ = 0 ,$$

$$\frac{\partial ω}{\partial θ} < 0 ∀ p , θ , and$$

$$\frac{\partial ω}{\partial p} < 0 ∀ p , θ .$$

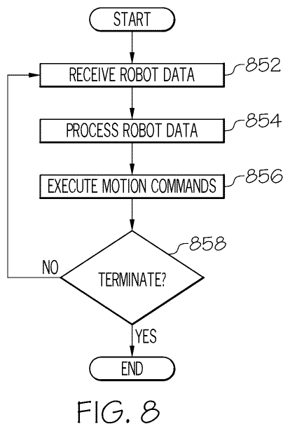

FIG. 8 depicts a flowchart for running a controller, according to embodiments provided herein. As illustrated in block 852, upon starting navigation, robot sensor and/or state information may be received. In block 854, the sensor and/or state information may be processed using a selected end-to-end controller to generate robot motion commands. This controller may be trained using the procedure of FIG. 7. The embodiment may combine the velocities provided by this trained controller with velocities predicted by an additional safety controller. Specifically, embodiments may choose velocities for the robot using a weighted sum of distances or readings returned by at least one sensor. The safety controller may be configured as an end-to-end range-sensor-driven controller. This controller maps a range measurement, or range scan, r(φ) to control inputs v and ω of the system. The output velocities of the safety controller may be added to the output velocities of the trained controller. In block 856, robot motion commands may be executed. In block 858, a determination may be made regarding whether to terminate operation. If the operation is not to be terminated, the process may return to block 852 to receive robot data. If so, the process may end.

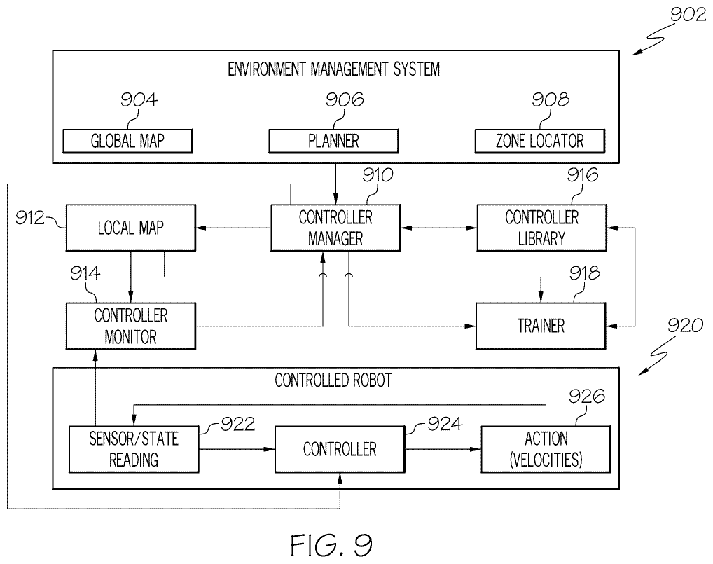

FIG. 9 depicts a system for controller management, according to embodiments provided herein. As illustrated, an environment management system 902 may be part of a cloud computing system, a local computing system, and/or an on-board system. Regardless, the environment management system 902 may include a global map 904, a planner 906, and a zone locator 908. The environment management system 902 may utilized the global map 904, the planner 906, and the zone locator 908 to determine a static layout of an environment and send that data to a controller manager 910.

Also provided is the controller manager 910, a local map 912, a controller monitor 914, a controller library 916, and a trainer 918. The controller manager 910 may receive data related to the global map 904, the planner 906, and the zone locator 908. The controller manager may also communicate with the controller library 916 to acquire the proper module for the desired result. The controller manager 910 may then send the data to create and/or update the local map 912. Additionally, the trainer 918 may communicate with the controller library 916, the controller manager 910, and the local map to further train the system in providing the proper end-to-end controller. The controller monitor may similarly receive data from the local map 912 and the controlled robot 920 to provide data back to the controller manager 910.

The controlled robot 920 may include sensors for receiving sensor and/or state readings 922, a controller 924, and velocities 926. Specifically, the sensor readings 922 may be received and provided to the controller 924. The controller 924 may communicate actions o the robot to the velocities 926, which may be packaged with the sensor readings for providing back to the controller monitor 914. The controller manager 910 may then provide instructions to the controller 924 for controlling the controlled robot 920.

As an example, if a robot is traversing a path and encounters an obstacle that prevents the robot from traveling that path, sensor data 922 (such as via a laser radar (LiDAR) system) may indicate a location of the obstacle. The robot may then determine one or more imagined positions (R1, R2, R3, . . . , RN) in the local map 912 locally available to it. The robot may predict the robot sensor data that would be obtained in the imagined positions, which may help train the controller 924 whose parameters satisfy the predetermined mathematical condition (or more than one) on the spatial derivatives of the controller. Parameters that satisfy these conditions would ensure a return to the path, and motion along the path while avoiding (e.g., turning away) from walls and the obstacle when too close to such objects.

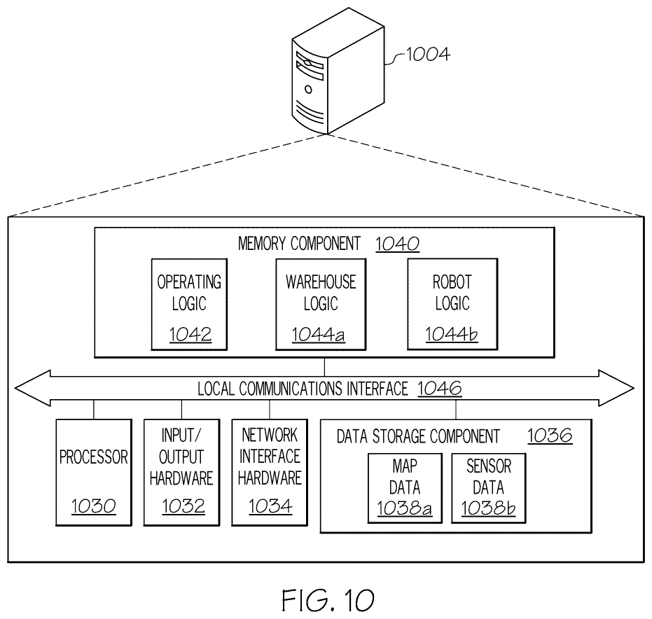

FIG. 10 depicts a computing device 1004 for providing end-to-end range-based controllers for navigating indoor environments, according to embodiments provided herein. As illustrated, the computing device 1004 represents a robot computing device, cloud computing device, local computing device, etc. and includes a processor 1030, input/output hardware 1032, a network interface hardware 1034, a data storage component 1036 (which stores code and data, such as map data 1038a and/or sensor 1038b, and a memory component 1040. The memory component 1040 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD) (whether local or cloud-based), and/or other types of non-transitory computer-readable medium. Depending on the particular embodiment, these non-transitory computer-readable mediums may reside within the computing device 1004 and/or external to the computing device 1004.

The memory component 1040 may store operating logic 1042, the environment logic 1044a and the robot logic 1044b. Each of these logic components may include a plurality of different pieces of logic, each of which may be embodied as a computer program, firmware, and/or hardware, as an example. A local interface 1046 is also included in FIG. 10 and may be implemented as a bus or other communication interface to facilitate communication among the components of the computing device 1004.

The processor 1030 may include any processing component operable to receive and execute instructions (such as from a data storage component 1036 and/or the memory component 140). As described above, the input/output hardware 1032 may include and/or be configured to interface with speakers, microphones, and/or other input/output components.

The network interface hardware 1034 may include and/or be configured for communicating with any wired or wireless networking hardware, including an antenna, a modem, a LAN port, wireless fidelity (Wi-Fi) card, WiMAX card, mobile communications hardware, transceiver, and/or other hardware for communicating with other networks and/or devices. From this connection, communication may be facilitated between the robot, a remote computing device (such as computing device 104), and other computing devices.

The operating logic 1042 may include an operating system and/or other software for managing components of the computing device 1004. The environment logic 1044a may represent one or more components of the environment management system 902 (FIG. 9) and thus may be configured to cause the processor 1030 to determine and/or store a global map 904, create and/or execute a planner 906, create and/or execute a zone locator 908, and/or provide other function, as provided herein. The robot logic 1044b may represent components of the controlled robot 920, and/or the controller manager 910, controller monitor 914, trainer 918, and/or other components provided herein. As such, the robot logic 1044b be configured to cause the processor 1030 to receive data from the environment logic 1044a for providing the robot functionality provided herein.

It should be understood that while the components in FIG. 10 are illustrated as residing within the computing device 1004, this is merely an example. In some embodiments, one or more of the components may reside external to a single computing device 1004 or within other devices, such as an AMR. It should also be understood that, while the computing device 1004 is illustrated as a single device, this is also merely an example. In some embodiments, the environment logic 1044a and/or the robot logic 1044b may reside on different computing devices.

As an example, one or more of the functionalities and/or components provided herein may be provided by the computing device 1004 and/or AMR. Depending on the particular embodiment, any of these devices may have similar components as those depicted in FIG. 10. To this end, any of these devices may include logic for performing the functionality provided herein.

Additionally, while the computing device 1004 is illustrated with the environment logic 1044a and the robot logic 1044b as separate logical components, this is also an example. In some embodiments, a single piece of logic may provide the described functionality. It should also be understood that while the environment logic 1044a and the robot logic 1044b are provided herein as the logical components, this is also an example. Other components may also be included, depending on the embodiment.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

It should now be understood that embodiments disclosed herein include systems, methods, and non-transitory computer-readable mediums for end-to-end range-based controllers for navigating indoor environment. It should also be understood that these embodiments are merely exemplary and are not intended to limit the scope of this disclosure.

What is claimed is:

1. A system for navigating an environment, comprising:
a robot with at least one sensor; and
a computing device with a processor and a memory component that stores logic, wherein the logic, when executed by the processor, causes the system to perform at least the following:
receive a local map of the environment;
define a desired path of the robot in the environment, wherein the path is represented as a sequence of locations in the environment;
predict sensor readings of the at least one sensor at a first location on the path and a second location off the path using the local map, wherein predicting sensor readings includes utilizing a digital twin of the local map;
predict a spatial derivative of a parameterized controller at a location on the path;
predict controller output values at a location on the desired path using the sensor readings;
compute controller parameter values such that that the spatial derivative and the controller output values are closer to satisfying a predetermined mathematical condition;
evaluate whether the predetermined mathematical condition is satisfied; and
in response to determining that the predetermined mathematical condition is satisfied, execute the controller parameter values to control the robot through the environment.

2. The system of claim 1, wherein the local map is created from processed sensor data.

3. The system of claim 1, wherein the local map includes at least one of the following: an overhead map or a point cloud.

4. The system of claim 1, wherein the desired path does not pass through a predicted true current robot location in the local map.

5. The system of claim 1, in response to determining that the predetermined mathematical condition is not met, again compute the controller parameter values.

6. The system of claim 1, wherein controlling the robot through the environment includes at least the following:
receive robot sensor data;
process the robot sensor data using an end-to-end controller to generate robot motion commands;
execute the robot motion commands.

7. The system of claim 1, wherein the at least one sensor includes at least one of the following: a laser radar (LiDAR) system, an image capture device, a radar system, or a real time location system (RTLS) sensor.

8. The system of claim 1, wherein the logic further causes the system to choose a velocity for the robot using a weighted sum of distances or reading returned by the at least one sensor.

9. The system of claim 1, wherein the digital twin is configured as an updatable map, within which the locations of objects can be updated in real-time.

10. The system of claim 1, wherein the environment is divided into a plurality of zones and wherein the parameterized controller is zone-specific.

11. The system of claim 1, wherein the parameterized controller is designed in real time.

12. The system of claim 1, wherein the logic further causes the system to implement object detection models on edge-ML devices using deep learning for object recognition.

13. A system for navigating an environment comprising:
a robot with at least one sensor; and
a computing device that is coupled to the robot, the computing device including a memory component that stores logic that, when executed by the computing device, causes the system to perform at least the following:
receive a local map of the environment;
define a desired path of the robot in the environment, wherein the path is represented as a sequence of locations in the environment;
predict sensor readings of the at least one sensor at a location on the path using the local map, wherein predicting sensor readings includes creating and utilizing a digital twin of the local map;
design an end-to-end range-based controller for the robot;
predict a spatial derivative of the end-to-end range-based controller at a location on the path;
predict controller output values of the end-to-end range-based controller at a location on the desired path using the sensor readings;
compute controller parameter values such that that the spatial derivative and the controller output values are closer to satisfying a predetermined mathematical condition;
evaluate whether the predetermined mathematical condition is satisfied; and
in response to determining that the predetermined mathematical condition is satisfied, execute the controller parameter values to control the robot through the environment.

14. The system of claim 13, wherein the local map is created from processed sensor data and wherein the local map includes at least one of the following: an overhead map or a point cloud.

15. The system of claim 13, wherein controlling the robot through the environment includes at least the following:
receive robot sensor data;
process the robot sensor data using the end-to-end range-based controller to generate robot motion commands;
execute the robot motion commands.

16. The system of claim 13, wherein the environment is divided into a plurality of zones and wherein the end-to-end range-based controller is zone-specific.

17. A system for navigating an environment comprising:
a robot with at least one sensor; and
a computing device that is coupled to the robot, the computing device including a memory component that stores logic that, when executed by the computing device, causes the system to perform at least the following:
receive a local map of the environment;
define a desired path of the robot in the environment, wherein the path is represented as a sequence of locations in the environment;
predict sensor readings of the at least one sensor at a location off the path using the local map, wherein predicting sensor readings includes creating and utilizing a digital twin of the local map;
design an end-to-end controller for the robot;
predict a spatial derivative of the end-to-end controller at a location on the path;
predict controller output values of the end-to-end controller at a location on the desired path using the sensor readings;
compute controller parameter values such that that the spatial derivative and the controller output values are closer to satisfying a predetermined mathematical condition;
evaluate whether the predetermined mathematical condition is satisfied; and
in response to determining that the predetermined mathematical condition is satisfied, execute the controller parameter values to control the robot through the environment.

18. The system of claim 17, wherein:
the local map is created from processed sensor data,
the local map includes at least one of the following: an overhead map or a point cloud,
the desired path does not pass through a predicted true current robot location in the local map,
in response to determining that the predetermined mathematical condition is not met, the logic causes the system to again compute the controller parameter values,
the at least one sensor includes at least one of the following: a laser radar (LiDAR) system, an image capture device, a radar system, or a real time location system (RTLS) sensor,
the logic further causes the system to choose a velocity for the robot using a weighted sum of distances returned by the at least one sensor,
the digital twin is configured as an updatable map, within which the locations of objects can be updated in real-time,
the environment is divided into a plurality of zones and wherein the end-to-end controller is zone-specific, and
the end-to-end controller is designed in real time.

19. The system of claim 17, wherein controlling the robot through the environment includes at least the following:
receive robot sensor data;
process the robot sensor data using the end-to-end controller to generate robot motion commands;
execute the robot motion commands.

20. The system of claim 17, wherein the environment is divided into a plurality of zones and wherein the end-to-end controller is zone-specific.
